(19) United States
(12) Patent Application Publication
(10) Pub. No.: US 2024/0009663 A1
(43) Pub. Date: Jan. 11, 2024

(54) CARTRIDGE AND IMMUNOCHROMATOGRAPHIC ASSAY APPARATUS

(71) Applicant: FUJIFILM Corporation, Tokyo (JP)

(72) Inventors: Yasutake TANAKA, Kanagawa (JP); Hiroyasu ISHII, Kanagawa (JP)

(73) Assignee: FUJIFILM Corporation, Tokyo (JP)

(21) Appl. No.: 18/471,498

(22) Filed: Sep. 21, 2023

Related U.S. Application Data
(63) Continuation of application No. PCT/JP2022/009822, filed on Mar. 7, 2022.

(30) Foreign Application Priority Data
Mar. 24, 2021 (JP) 2021-050777

(51) Int. Cl. B01L 3/00

(52) U.S. Cl. CPC B01L 3/5023; B01L 2400/0481; B01L 2200/16

(57) ABSTRACT

The cartridge includes a carrier having a spotting region and an assay region, a first reagent holding part that holds a first reagent and that starts a supply of the first reagent to the carrier by directly or indirectly receiving an external force, a second reagent holding part that starts a supply of the second reagent to the carrier by directly or indirectly receiving an external force exerted by an internal mechanism provided in the immunochromatographic assay apparatus, and a suppression structure that suppresses transmission of an external force exerted by a user directly or indirectly to the second reagent holding part or application of an external force by the user to the second reagent holding part, while allowing the external force exerted by the internal mechanism to be transmitted to the second reagent holding part.

### CROSS-REFERENCE TO RELATED APPLICATIONS

This application is a continuation of International Application No. PCT/JP2022/009822, filed on Mar. 7, 2022, which claims priority from Japanese Patent Application No. 2021-050777, filed on Mar. 24, 2021. The entire disclosure of each of the above applications is incorporated herein by reference.

### BACKGROUND

### 1. Technical Field

The present disclosure relates to a cartridge and an immunochromatographic assay apparatus.

### 2. Related Art

Among immunoassay methods, an immunochromatographic method is generally widely utilized, because operation is easy and assay can be performed within a short period of time.

WO2016/114122A and WO2017/104143A disclose an immunochromatographic kit using an immunochromatographic method. The immunochromatographic kit includes an immunochromatographic carrier to which a sample is supplied. The immunochromatographic carrier provides with an assay region on which an antibody that specifically binds to an antigen, which is a test substance, is immobilized. In a case where a labeled antibody that specifically binds to an antigen is developed on an immunochromatographic carrier together with a sample containing the antigen, the antigen binds to the antibody immobilized on the assay region and the labeling substance is captured via the antigen. In a case where the assay region develops a color by the labeling substance captured in the assay region, it is determined that the sample is positive. In a case where the amount of the labeling substance captured in the assay region is very small, the color development is weak and it may be determined that the sample is false negative. Therefore, WO2016/114122A and WO2017/104143A disclose an amplification technique for amplifying a labeling signal emitted by a labeling substance. The disclosed amplification technique is a silver amplification technique in which gold colloidal particles are used as a labeling substance and silver ions and a silver ion reducing agent are used as reagents for amplification. In the silver amplification, an amplification reaction is caused in which using the gold colloidal particles as a catalyst, silver particles having a relatively large particle diameter are generated. By this amplification reaction, the labeling signal emitted by the gold colloidal particles is amplified.

The immunochromatographic kits according to WO2016/114122A and WO2017/104143A include a first amplifying liquid pod holding a first amplifying liquid (corresponding to a first reagent) containing a silver ion reducing agent, and a second amplifying liquid pod holding a second amplifying liquid (corresponding to a second reagent) containing silver ions. The immunochromatographic kit includes an operation structure such as a pressing button for applying a pressing force to the first amplifying liquid pod and a pressing button for applying a pressing force to the second amplifying liquid pod. By applying a pressing force through each operation structure, it is possible to supply the first amplifying liquid and the second amplifying liquid to the immunochromatographic carrier to cause an amplification reaction.

On the other hand, JP2012-103150A discloses an analysis apparatus that includes a loading part in which a cartridge corresponding to an immunochromatographic kit is loaded and optically analyzes a reaction state between a sample and a reagent in an assay region. The analysis apparatus includes a sensor that optically detects a reaction state and a display unit that displays the detection result. By using the analysis apparatus, it is possible for the user to perform determination mechanically whether the sample is a positive or negative only by performing the operation of loading the cartridge in which the sample is spread. The cartridge described in JP2012-103150A includes an amplifying liquid pod, and the analysis apparatus includes, in addition to the sensor and the display unit, an internal mechanism such as a pressing mechanism for pressing the amplifying liquid pod. Therefore, in the analysis apparatus, the amplifying liquid pod is pressed by the internal mechanism, and thus the amplifying liquid is supplied from the amplifying liquid pod to the immunochromatographic carrier.

### SUMMARY

As the immunochromatographic kits described in WO2016/114122A and WO2017/104143A, an immunochromatographic assay apparatus that performs an assay of a sample using a cartridge including a first reagent holding part corresponding to a first amplifying liquid pod and a second reagent holding part corresponding to a second amplifying liquid pod is known. In such a cartridge, a first operation button for starting the supply of the first reagent by applying an external force such as a pressing force to the first reagent holding part and a second operation button for starting the supply of the second reagent by applying an external force such as a pressing force to the second regent holding part are provided in the main body of the cartridge.

An immunochromatographic assay apparatus using such a cartridge includes an apparatus including an internal mechanism (such as a pressing mechanism described in JP2012-103150A) for operating the second operation button in which the supply of the second reagent is performed in the apparatus. In this case, before loading the cartridge, the user operates the first operation button of the cartridge to start the supply of the first reagent, and loads the cartridge in which the supply of the first reagent has been started into the immunochromatographic assay apparatus.

It may take several minutes or more to develop the first reagent. Therefore, by causing the user to perform the operation of the first operation button before loading, the assay time by the immunochromatographic assay apparatus, that is, the occupancy time for the cartridge to occupy the immunochromatographic assay apparatus can be reduced as compared with a case where both the supply of the first reagent and the supply of the second reagent are performed by the immunochromatographic assay apparatus. Therefore, an improvement in throughput can be expected in a case where a plurality of samples are assayed.

In a case where the immunochromatographic assay apparatus performs only the operation of the second operation button by an internal mechanism, by the erroneous operation by the user of the cartridge before loading, an appropriate assay may not be performed such as that an amplification reaction does not occur. The erroneous operation by the user is that not only the first operation button is operated but also the second operation button is operated before loading, that mistaking for the first operation button, only the second operation button is operated, or that the operation order of the first operation button and the second operation button is mistaken.

In a case where a cartridge in which such an erroneous operation has been performed is loaded, an appropriate assay may not be performed in the immunochromatographic assay apparatus. Therefore, a measure for suppressing an erroneous operation by a user regarding the supply of such a reagent has been desired.

The present disclosure has been made in view of the above circumstances, and an object of the present disclosure is to provide a cartridge and an immunochromatographic assay apparatus capable of suppressing an erroneous operation by a user regarding supply of a reagent in a case where the first reagent and the second reagent are used.

The cartridge of the present disclosure is a cartridge that is attachably and detachably loaded into an immunochromatographic assay apparatus, and includes
a carrier having a spotting region on which a sample is spotted and an assay region in which a color development state changes depending on whether the sample is positive or negative,
a first reagent holding part that holds a first reagent and that starts a supply of the first reagent to the carrier by directly or indirectly receiving an external force,
a second reagent holding part that holds a second reagent that is supplied to the carrier after the first reagent is supplied to the carrier, and that starts a supply of the second reagent to the carrier by directly or indirectly receiving an external force exerted by an internal mechanism provided in the immunochromatographic assay apparatus, and
a suppression structure that suppresses transmission of an external force exerted by a user directly or indirectly to the second reagent holding part or application of an external force by the user to the second reagent holding part, while allowing the external force exerted by the internal mechanism to be transmitted to the second reagent holding part.

In the cartridge of the present disclosure, the suppression structure has a cover member that covers the second reagent holding part and has an opening for exerting the external force on the second reagent holding part, and the opening has a form in which a member of the internal mechanism is allowed to be inserted, but a finger of the user is not allowed to be inserted.

In the cartridge of the present disclosure, an opening width of the opening is preferably 5 mm or less.

In the cartridge of the present disclosure, the suppression structure may have a pressed part that is deformed or displaced by receiving a pressing force as the external force and that transmits an operating force that is a force of magnitude necessary for starting the supply of the second reagent to the second reagent holding part by the deformation or the displacement.

In the cartridge of the present disclosure, it is preferable that the pressed part transmits the operating force to the second reagent holding part in a case where the pressing force is 50 N or more but does not transmit the operating force in a case where the pressing force is less than 50 N.

The cartridge of the present disclosure may further include a cover member having a pressed part that is deformed or displaced by receiving a pressing force as the external force and that transmits an operating force that is a force of magnitude necessary for starting the supply of the second reagent to the second reagent holding part by the deformation or the displacement, or an opening for exerting the external force on the second reagent holding part, and the suppression structure may have the pressed part or a coating member that covers the opening.

In the cartridge of the present disclosure, at least the second reagent among the first reagent and the second reagent is preferably an amplifying liquid that amplifies color development in the assay region.

In the cartridge of the present disclosure, the first reagent and the second reagent are preferably amplifying liquids that amplify color development in the assay region by reacting with both of the first reagent and the second reagent.

In the cartridge of the present disclosure, preferably, the carrier further includes a color development region in which a color development state changes by a reaction with the first reagent, and in a case where a direction toward the assay region with respect to the spotting region is defined as a downstream side of the carrier, the color development region is disposed on a downstream side of the assay region and the first reagent holding part is provided on an upstream side of the spotting region.

In the cartridge of the present disclosure, in a case where a direction toward the assay region with respect to the spotting region is defined as a downstream side of the carrier, the carrier preferably has a control region that is provided on a downstream side of the assay region and that shows a development of the sample supplied from the spotting region to the carrier in the assay region by a change in color development state.

The immunochromatographic assay apparatus of the present disclosure includes a loading part in which the cartridge of the present disclosure is attachably and detachably loaded, and the internal mechanism.

In the immunochromatographic assay apparatus of the present disclosure, the internal mechanism may include an insertion member capable of being inserted into the opening.

In the immunochromatographic assay apparatus of the present disclosure, the internal mechanism may be capable of pressing the pressed part with a pressing force of 50 N or more.

According to the cartridge and the immunochromatographic assay apparatus of the present disclosure, an erroneous operation by a user regarding the supply of the reagents in a case where the first reagent and the second reagent are used can be suppressed.

### BRIEF DESCRIPTION OF THE DRAWINGS

FIG. 1 is a perspective view showing appearance of an immunochromatographic assay apparatus.

FIG. 2 is a perspective view of a cartridge.

FIG. 3 is an exploded perspective view of the cartridge.

FIG. 4 is a diagram showing a positional relationship between an assay strip, a multifunctional member, a first reagent holding part, and a second reagent holding part, in the cartridge.

FIG. 5 is a diagram showing before and after a second pressed part of the cartridge according to a first embodiment is pressed.

FIG. 6 is an explanatory diagram of an immunochromatographic method.

FIG. 7 is a partially broken side view of an assay apparatus in a state where the cartridge is loaded.

FIG. 8 is a diagram showing a first assay flow.

FIG. 9 is a diagram showing a first assay flow in an assay apparatus.

FIG. 10 is a perspective view of a cartridge according to a second embodiment.

FIG. 11 is a diagram showing before and after a second reagent supply mechanism is inserted into the opening of the cartridge according to the second embodiment and the supply of a second reagent is started.

FIG. 12 is a perspective view of a cartridge according to a third embodiment.

### DESCRIPTION OF EMBODIMENTS

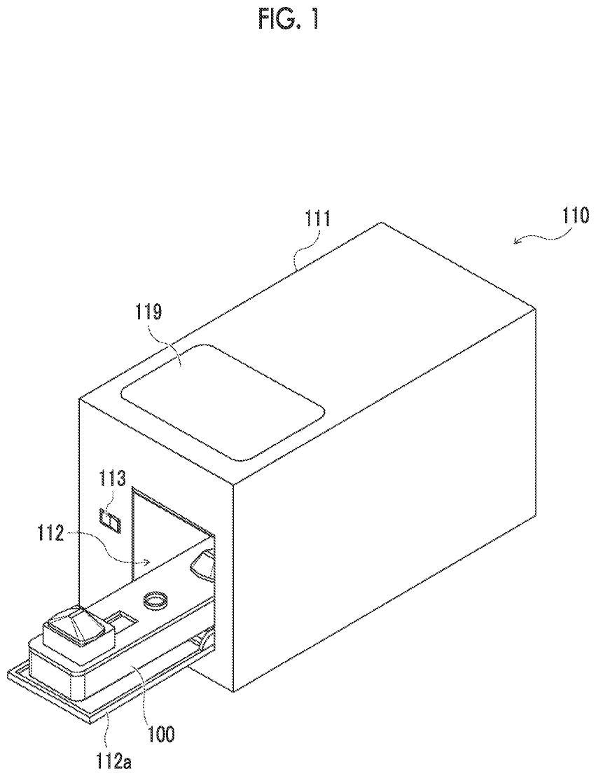

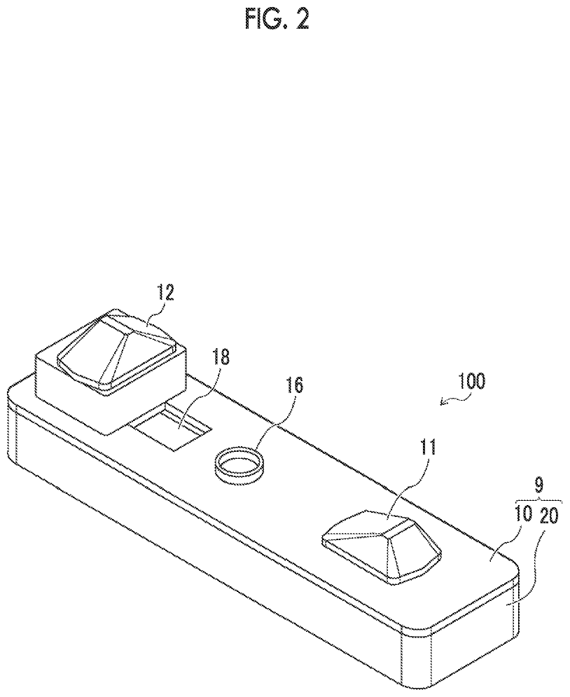

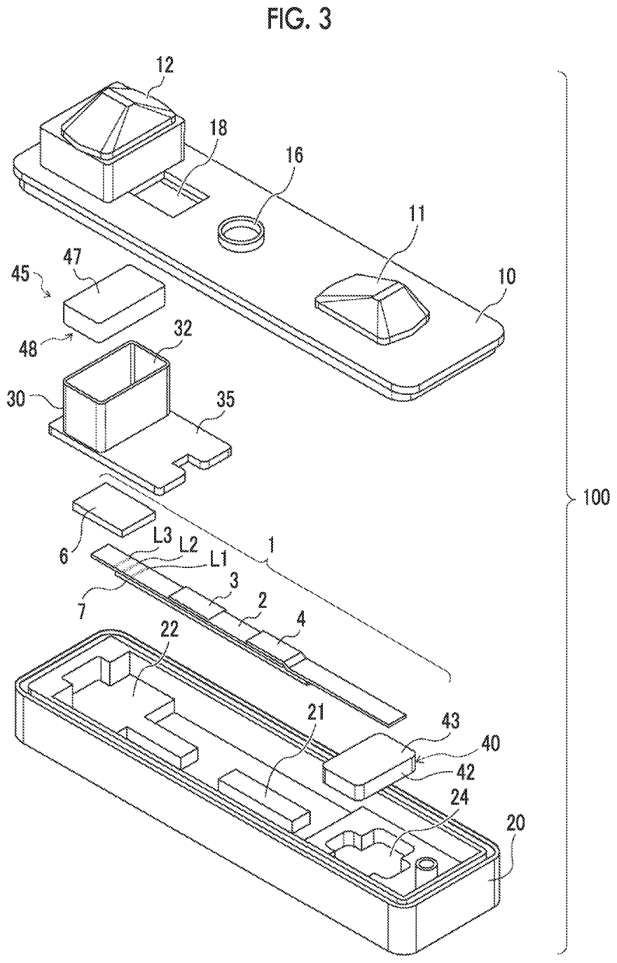

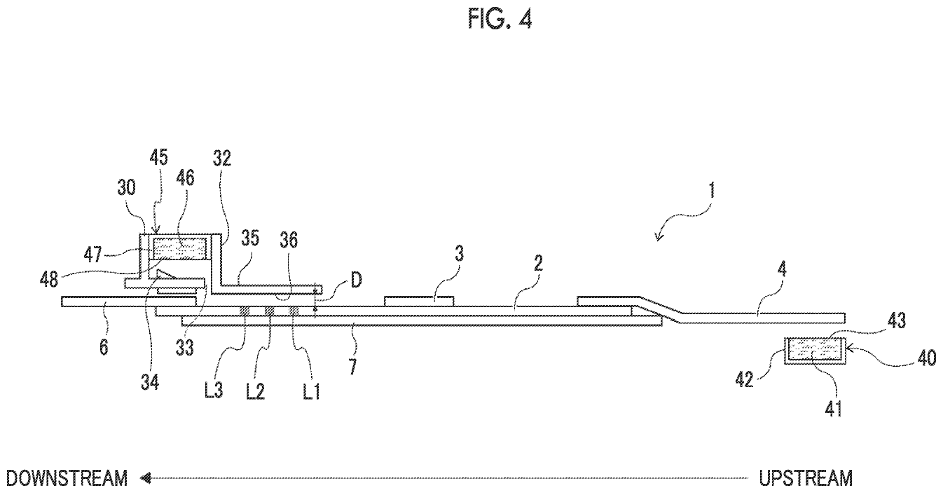

Embodiments of the immunochromatographic assay apparatus of the present disclosure will be described with reference to the drawings. FIG. 1 is a perspective view showing the appearance of an immunochromatographic assay apparatus 110 (hereinafter, simply referred to as an assay apparatus 110) according to one embodiment. FIG. 2 is an external view of a cartridge 100 loaded into the assay apparatus 110 and FIG. 3 is an exploded perspective view of the cartridge 100. FIG. 4 is a diagram showing the positional relationship of the main accommodated components in the cartridge 100.

The cartridge 100 is a single-use type that is used one by one for each sample of assay target. As shown in FIG. 3, an assay strip 1 including an immunochromatographic carrier 2 (hereinafter, referred to as a carrier 2) is provided in the cartridge 100. An assay region L1 is provided in the carrier 2, and the color development state changes depending on whether or not the sample contains a test substance, that is, whether the sample is positive or negative.

The sample is simply required to be a specimen that may contain a test substance, and the sample is not particularly limited. The sample is, for example, a biological specimen, particularly body fluid or excrement of an animal (particularly, a human) such as blood, serum, blood plasma, spinal fluid, tear fluid, sweat, urine, pus, nasal mucus, nasal swab, throat swab, nasal aspirate, or sputum, an organ, a tissue, a mucous membrane and skin, or swabs containing them, or a liquid specimen containing animals and plants themselves or a dried body thereof. Examples of the test substance include an antigen, an antibody, a protein, and a low-molecular-weight compound.

In the assay apparatus 110 of the present example, the cartridge 100 in a state in which the sample is spotted is loaded. Then, the assay apparatus 110 detects a color development state of the assay region L1 of the loaded cartridge 100, and presents the result of whether the sample is positive or negative. In a case of where a plurality of samples are assayed, the cartridge 100 for each sample is loaded one by one into the assay apparatus 110.

Hereinafter, the cartridge 100 will be described on the premise that the cartridge 100 is loaded into the assay apparatus 110. However, the cartridge 100 of the present example has a configuration that a user can confirm visually whether the sample is positive or negative without using the assay apparatus 110. Such a cartridge 100 is also referred to as an immunochromatographic assay tool, an immunochromatographic assay kit, or the like.

As shown in FIG. 1, the assay apparatus 110 includes a case body 111, and the case body 111 includes a cartridge loading part 112 in which the cartridge 100 is attachably and detachably loaded. As an example, an opening for inserting the cartridge 100 into the case body 111 and an opening and closing lid 112a for opening and closing the opening are provided on the front surface of the case body 111. The opening and closing lid 112a is opened when the cartridge 100 is loaded, the cartridge 100 is inserted into the case body 111, and the opening and closing lid 112a is closed after the cartridge 100 has been loaded into the cartridge loading part 112. The assay is performed in a state where the opening and closing lid 112a is closed.

In addition, a power switch 113 is provided on the front surface of the case body 111, and a monitor 119 is provided on the upper surface of the case body 111. A determination result, an error message, and the like are displayed on the monitor 119. As an example, the monitor 119 is a touch panel monitor, and various operation screens are displayed. Through the operation screen, the user can input a start instruction of processing and an operation instruction such as selection of an assay procedure.

As shown in FIG. 2 and FIG. 3, as an example, the cartridge 100 includes a housing 9 constituted of a case member 20 and a cover member 10. The housing 9 is formed of, for example, a resin material. An opening is formed in an upper part of the case member 20, and in addition to the assay strip 1, a first reagent holding part 40, a second reagent holding part 45, and the like are accommodated therein. The cover member 10 covers the opening of the case member 20 by being attached to the opening part of the case member 20. The housing 9 has an elongated shape as a whole in accordance with the elongated shape of the assay strip 1.

In the present example, a dropping port 16, an observation window 18, a first pressed part 11, and a second pressed part 12 are provided on an upper part of the housing 9 constituted of the cover member 10. Each of these parts is integrally molded with the cover member 10 as an example. The dropping port 16 is an opening for adding dropwise a sample into the inside of the housing 9. A boss is vertically provided on the edge of the dropping port 16 toward the upper part. The observation window 18 is a window for observing the assay region L1 from the outside, and is formed of a transparent member as an example. In the present example, the size of the observation window 18 is a size such that, in addition to the assay region L1, the control region L2 and the color development region L3, which will be described later, can also be observed.

The first pressed part 11 is an operating part operated to supply a first reagent 41 (see FIG. 4) in the first reagent holding part 40 to the carrier 2. The second pressed part 12 is an operating part operated to supply the second reagent 46 (see FIG. 4) in the second reagent holding part 45 to the carrier 2. As will be described later, the first reagent 41 and the second reagent 46 are amplifying liquids for amplifying the color development in the assay region L1 in a case where a sample 50 is positive.

In a case where a pressing force is applied from the outside as an external force to the first pressed part 11, the first pressed part 11 is deformed. As an example, the first pressed part 11 has a quadrangular pyramid shape, and in a case where a pressing force is applied from above to a region including the apex of the quadrangular pyramid, the first pressed part 11 is deformed such that the apex of the quadrangular pyramid sinks into the inside of the housing 9. In a case of where the first pressed part 11 is deformed in this manner, a pressing force is applied to the first reagent holding part 40 inside the housing 9. In the first reagent holding part 40, deformation or the like due to a pressing force applied through the first pressed part 11 occurs. Due to this deformation or the like, the first reagent 41 held by the first reagent holding part 40 is supplied to the assay strip 1.

In addition, it is preferable that the first pressed part 11 is deformed by pressing and then the deformed state is maintained. The reason is as follows. As will be described later, in the assay apparatus 110 of the present example, the cartridge 100 in a state in which the first pressed part 11 is pressed in advance by the user can be loaded. It is because, in a case where the first pressed part 11 is pressed by the user before being loaded into the assay apparatus 110, the first pressed part 11 in which the deformation is maintained even after the user releases the hand, is easier to continue the supply of the first reagent 41.

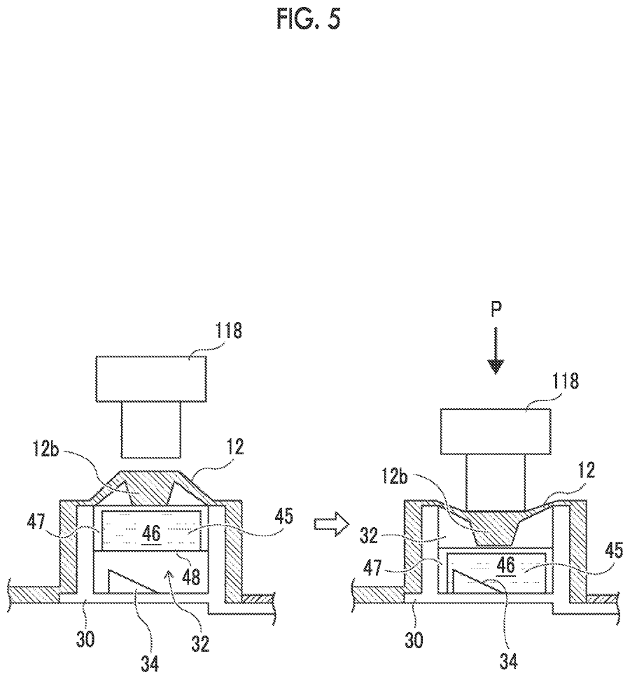

Similarly, in a case where a pressing force is applied from the outside as an external force to the second pressed part 12, the second pressed part 12 is deformed. FIG. 5 shows a state before and after the pressing force is applied to the second pressed part 12. Similarly to the first pressed part 11, the second pressed part 12 of the present example also has a quadrangular pyramid shape, and in a case where a pressing force is applied from above to a region including the apex of the quadrangular pyramid, the second pressed part 12 is deformed such that the apex of the quadrangular pyramid sinks into the inside of the housing 9. In a case of where the second pressed part 12 is deformed in this manner, a pressing force is applied to the second reagent holding part 45 inside the housing 9. In the second reagent holding part 45, deformation or the like due to a pressing force applied through the second pressed part 12 occurs. Due to this deformation or the like, the second reagent 46 held by the second reagent holding part 45 is supplied to the assay strip 1. In the second pressed part 12 of the present example, an abutting part 12b that abuts on the second reagent holding part 45 is provided. In this way, the second pressed part 12 is deformed by receiving a pressing force as an external force, and transmits an operating force that is a force of magnitude necessary for starting the supply of the second reagent 46 to the second reagent holding part 45 by the deformation.

In the present embodiment, the second pressed part 12 transmits the operating force to the second reagent holding part 45 in a case where the pressing force is 50 N or more but does not transmit the operating force in a case where the pressing force is less than 50 N. That is, in a case where the pressing force applied from the outside is less than 50 N, the second pressed part 12 cannot start the supply of the second reagent 46. In order to start the supply of the second reagent 46, it is necessary to apply a pressing force of 50 N or more to the second pressed part 12.

In addition, unlike the first pressed part 11, the second pressed part 12 is pressed by the internal mechanism of the assay apparatus 110 in any of the assay flows that can be selected in the assay apparatus 110. Therefore, the second pressed part 12 may be depressible by an internal mechanism.

In a case where the pressing force necessary for pushing down the second pressed part 12 is 50 N or more, the second pressed part 12 cannot be pushed down with an ordinary human finger. The second pressed part 12 is a constituent element of a suppression structure that suppresses transmission of an external force exerted by a user directly or indirectly to the second reagent holding part 45 while allowing the external force exerted by the internal mechanism to be transmitted to the second reagent holding part 45. The second pressed part 12 has an elastic member or structure having a rigidity enough not to be deformed by a pressing force of less than 50 N. More specifically, for example, the second pressed part 12 is devised for increasing the rigidity by selecting dimensions, shapes, arrangements, materials, and the like of members constituting the second pressed part 12. In addition, the second pressed part 12 itself may have a rigidity enough not to be deformed by a pressing force of less than 50 N, or a spring provided for cooperation with the second pressed part 12 may have a rigidity enough not to be deformed by a pressing force of less than 50 N.

As shown in FIG. 3 and FIG. 4, the case member 20 accommodates the assay strip 1 including the carrier 2 along the longitudinal direction. In the case member 20, the first reagent holding part 40 is disposed on one end part side (upstream side shown in FIG. 4) in the longitudinal direction. In the case member 20, in a portion where the first reagent holding part 40 is disposed, the first accommodating part 24 that is a recess-shaped in accordance with the shape of the first reagent holding part 40 is formed. One end part of the assay strip 1 is disposed above the first reagent holding part 40 in a state of being accommodated in the first accommodating part 24.

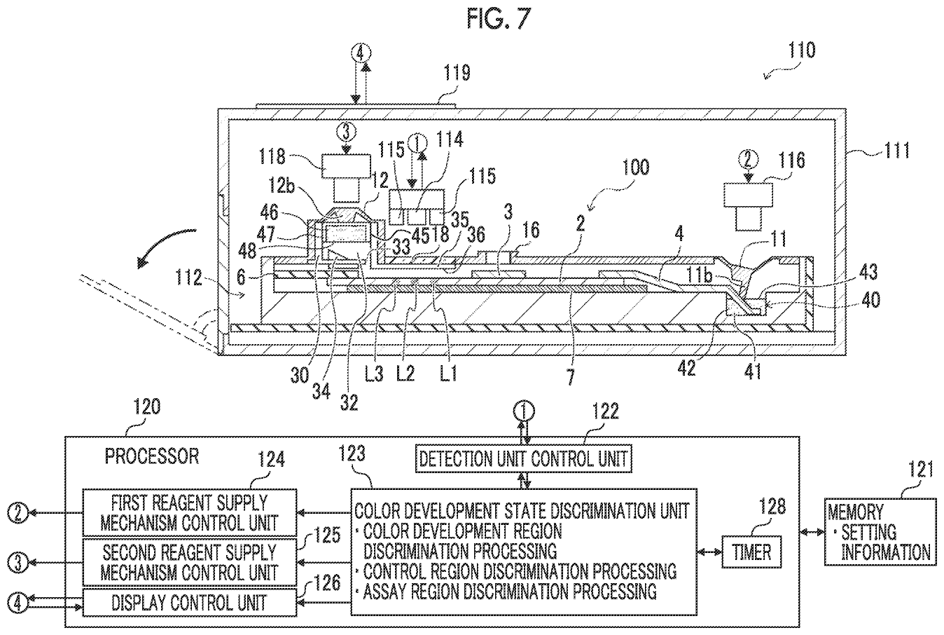

The first reagent holding part 40 holds the first reagent 41. The first reagent holding part 40 is constituted of, for example, a container 42 formed of a resin material and having an opening on one surface, and a sheet member 43 that covers the opening of the container 42 and is breakable. The container 42 is filled with the first reagent 41, and the opening of the container 42 is sealed by the sheet member 43. The first reagent holding part 40 is disposed in the first accommodating part 24 in a posture in which the sheet member 43 faces upward. The pressing force applied from the first pressed part 11 is transmitted to the sheet member 43 of the first reagent holding part 40 via the end part of the assay strip 1 to break the sheet member 43 (see FIG. 7). The sheet member 43 is broken, and thus the first reagent 41 is supplied to the assay strip 1. In the first pressed part 11 of the present example, a protruding part 11b that abuts on the sheet member 43 (see FIG. 7). The protruding part 11b has, for example, an elongated shape in which the longitudinal direction extends in the width direction of the assay strip 1, and a shape in which the tip end is pointed toward the sheet member 43, such that the sheet member 43 is easily broken.

In addition, the cartridge 100 includes a multifunctional member 30 having a function of accommodating the second reagent holding part 45. The multifunctional member 30 is disposed on the other end part side (downstream side shown in FIG. 4) of the case member 20 and above the assay strip 1. The multifunctional member 30 is a member in which the second accommodating part 32 and the flow channel forming part 35 are integrally formed. The second accommodating part 32 is a part accommodating the second reagent holding part 45. The second accommodating part 32 has a box shape having an opened upper surface. As shown in FIG. 4, on the bottom of the second accommodating part 32, a protrusion 34 for breaking a sheet member 48, which will be described later, of the second reagent holding part 45, and an opening 33 that allows to flow the second reagent 46 flowed out from the second reagent holding part 45, toward the carrier 2.

The flow channel forming part 35 is provided to be connected to the upstream side from the second accommodating part 32. The flow channel forming part 35 has a flat plate shape, is disposed at a position facing the assay region L1 or the like in the longitudinal direction of the carrier 2, and is disposed with an interval from the carrier 2. Then, between the flow channel forming part 35 and the carrier 2, a flow channel for flowing the second reagent 46 flowed out from the second accommodating part 32 toward the assay region L1 or the like is formed. In this way, the flow channel forming part 35 is disposed between the observation window 18 and the assay region L1 or the like of the carrier 2. Therefore, the flow channel forming part 35 is formed of a transparent member and thus the assay region L1 and the like can be observed through the observation window 18.

The second reagent holding part 45 holds the second reagent 46. The second reagent holding part 45 is constituted of, for example, a container 47 formed of a resin material and having an opening on one surface, and a sheet member 48 that covers the opening of the container 47 and is breakable. The container 47 is filled with the second reagent 46, and the opening of the container 47 is sealed by the sheet member 48. The second reagent holding part 45 is disposed in the second accommodating part 32 in a posture in which the sheet member 48 faces downward. Accordingly, the sheet member 48 faces the protrusion 34 in the second accommodating part 32.

The pressing force applied from the second pressed part 12 to the second reagent holding part 45 acts in a direction of pushing down the second reagent holding part 45 downwardly, whereby the sheet member 48 is pressed against the protrusion 34. The sheet member 48 is pressed against the protrusion 34 to break the sheet member 48 (see FIG. 5). The sheet member 48 is broken, and thus the second reagent 46 is supplied to the carrier 2 through the flow channel formed by the opening 33 at the bottom of the second accommodating part 32 and the flow channel forming part 35.

As shown in FIG. 4, a gap (a clearance) D corresponding to the flow channel for the second reagent 46 is formed between a back surface 36 of the flow channel forming part 35 of the multifunctional member 30 and the carrier 2 of the assay strip 1. The gap D is, for example, in the range of 0.01 mm to 1 mm. The second reagent 46 flows out from the opening 33 at the bottom of the second accommodating part 32 toward the carrier 2, and the second reagent 46 that has flowed out flows through the flow channel formed by the gap D and reaches at least above the assay region L1. The second reagent 46 that has reached the assay region L1 infiltrates the assay region L1 from the flow channel.

An absorption pad 6, which will be described later, is disposed at an end part on the downstream side of the assay strip 1. In the case member 20, a support part 22 that supports an end part of the assay strip 1 including the absorption pad 6 is formed at a position facing the absorption pad 6. A second accommodating part 32 of the multifunctional member 30 is disposed above the absorption pad 6. The support part 22 also supports the multifunctional member 30 via the absorption pad 6. In addition, in the case member 20, a support part 21 that supports a central part of the assay strip 1 is formed.

The assay strip 1 includes the carrier 2, a liquid feeding pad 4, and the absorption pad 6. Then, the carrier 2 is fixedly supported on a back pressure-sensitive adhesive sheet 7.

The carrier 2 is a porous insoluble carrier for developing a sample, and includes an assay region L1, a control region L2, and a color development region L3. In addition, the carrier 2 includes a label holding pad 3. The label holding pad 3 constitutes a spotting region on which the sample is spotted. The color development region L3 is disposed on the downstream side of the assay region L1 in a case where the direction toward the assay region L1 with respect to the spotting region is the downstream side of the carrier 2. In the present example, the assay region L1, the control region L2, and the color development region L3 are line-shaped regions extending in a direction perpendicular to the development direction of the sample in the carrier 2.

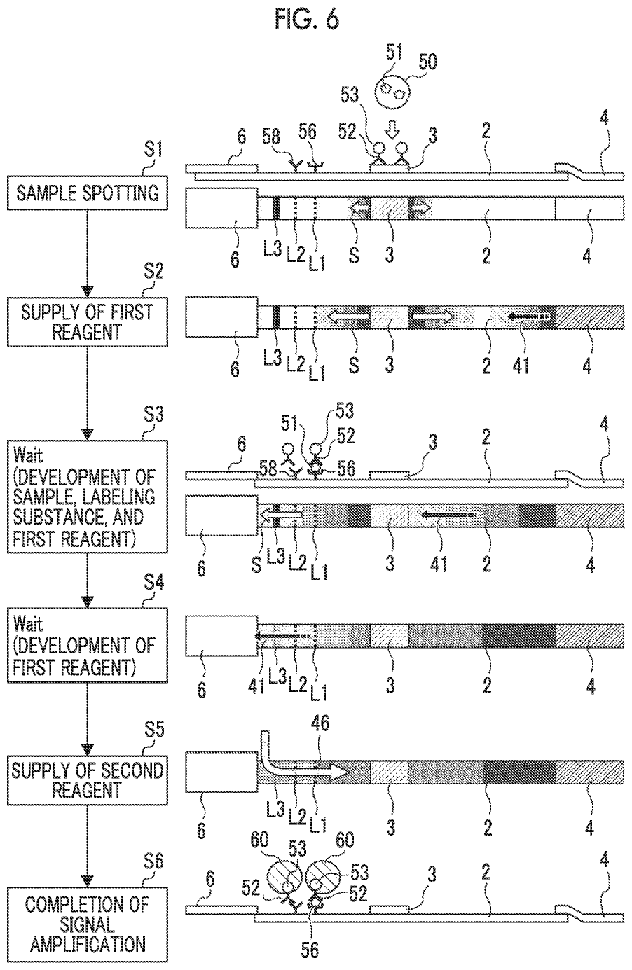

It shows a state in which the assay region L1, the control region L2, and the color development region L3 are expressed as lines, but these are not always expressed. Details will be described later, but before developing the sample 50 (see FIG. 6), the first reagent 41 (see FIG. 4), and the second reagent 46 (see FIG. 4), the colors of the assay region L1 and the control region L2 are substantially the same as the color of the carrier 2 (for example, white), and thus the assay region L1 and the control region L2 cannot be clearly visually recognized at this stage. The assay region L1 is expressed as a line by increasing the color optical density in a case where the sample 50 is developed and the developed sample 50 is positive. As a result, the assay region L1 becomes visible. Since the color development of the assay region L1 is amplified by silver amplification, which will be described later, the assay region L1 develops a black color.

The control region L2 is also expressed as a line by increasing the color optical density in a case where the sample 50 is developed. As a result, the control region L2 is visible. Since the color development of the control region L2 is also subjected to silver amplification, the control region L2 also develops a black color.

On the other hand, only the color development region L3 is expressed and visible as a blackish dark green color (hereinafter, referred to as a dark green color) line even in a stage before the first reagent 41 is developed. However, the color development region L3 is expressed as an orange line by changing a dark green color to an orange color in a case where the first reagent 41 is developed.

As the carrier 2, for example, a porous material such as a nitrocellulose membrane can be used. In addition, the back pressure-sensitive adhesive sheet 7 on which the carrier 2 is fixed is a sheet-shaped substrate having a pressure-sensitive adhesive surface to which the carrier 2 is attached.

As shown in FIG. 6, a labeling substance 53 is fixed to the label holding pad 3. The labeling substance 53 is modified with a first binding substance 52 that specifically binds to a test substance 51 contained in the sample 50. The label holding pad 3 is fixed on the carrier 2 at a position facing the dropping port 16 of the cover member 10. Therefore, the sample 50 is added dropwise onto the label holding pad 3 from the dropping port 16. Therefore, the label holding pad 3 corresponds to a spotting region on which the sample 50 is spotted.

The label holding pad 3 is fixed at a substantially center position in the longitudinal direction of the carrier 2. As the labeling substance 53, it is possible to use, for example, a gold colloidal particle having a diameter of 50 nm (EM. GC50, manufactured by BBI Solutions). The labeling substance 53 is not limited to the gold colloid, and a metal sulfide that can be used in a general chromatographic method, a coloring particle that are used in an immunoagglutination reaction, or the like can be used, where a metal colloid is particularly preferable. Examples of the metal colloid include a gold colloid, a silver colloid, a platinum colloid, an iron colloid, an aluminum hydroxide colloid, and a composite colloid thereof. In particular, at an appropriate particle diameter, a gold colloid is preferable since it exhibits a red color, a silver colloid is preferable since it exhibits a yellow color, and the gold colloid is most preferable among them.

As shown in FIG. 6, the assay region L1 includes a second binding substance 56 that specifically binds to the test substance 51 and captures the test substance 51. In the assay region L1, in a case where the test substance 51 is captured by binding the second binding substance 56 to the test substance 51, the first binding substance 52 bonded to the test substance 51 and the labeling substance 53 are captured. In a case where the test substance 51 is included in the sample 50, the test substance 51 and the labeling substance 53 are captured in the assay region L1, and thus the color optical density in the assay region L1 is increased to be not less than a preset reference. The assay region L1 is a region for confirming the presence or absence of the test substance 51 by a labeling signal from the labeling substance 53 captured via the test substance 51.

The control region L2 includes a third binding substance 58 that specifically binds to the first binding substance 52, and captures the labeling substance 53 via the first binding substance 52. In a case where the sample 50 is spotted on the label holding pad 3, the labeling substance 53 that is not bound to the test substance 51 among the labeling substances 53 modified with the first binding substance 52 is also developed in the carrier 2 toward the assay region L1 together with the sample 50. The labeling substance 53 that is not bound to the test substance 51 passes through the assay region L1 without being captured by the assay region L1. The labeling substance 53 that has passed through the assay region L1 is captured in the control region L2 via the first binding substance 52 by binding the first binding substance 52 to the third binding substance 58. The labeling substance 53 is captured in the control region L2, and thus the color optical density in the control region L2 is increased to be not less than a preset reference. The control region L2 is a region for confirming the completion of the development of the sample 50 by the labeling signal from the labeling substance 53 captured via the first binding substance 52. Therefore, the control region L2 may be referred to as a confirmation region.

The first binding substance 52 that modifies the labeling substance 53 and specifically binds to the test substance 51 is a substance that specifically binds to the test substance, for example, in a case where the test substance is an antigen, an antibody against the antigen, in a case where the test substance is an antibody, an antigen against the antibody, in a case where the test substance is a protein or a low-molecular-weight compound, an aptamer against the protein or the low-molecular-weight compound, or the like.

The second binding substance 56 that is fixed in the assay region L1 and specifically binds to the test substance 51 is a substance that specifically binds to the test substance, for example, in a case where the test substance is an antigen, an antibody against the antigen, in a case where the test substance is an antibody, an antigen against the antibody, in a case where the test substance is a protein or a low-molecular-weight compound, an aptamer against the protein or the low-molecular-weight compound, or the like. The first binding substance 52 and the second binding substance 56 may be the same as or different from each other.

The third binding substance 58 that specifically binds to the first binding substance 52 may be the test substance 51 itself or may be a compound having a site recognized by the first binding substance 52. Examples thereof include a compound obtained by binding a derivative of the test substance 51 to a protein, and the like.

For example, in a case where the test substance 51 is an influenza A virus or a biomarker thereof, anti-influenza A monoclonal antibody (Anti-Influenza A SPTN-5 7307, Medix Biochemica) can be used as the first binding substance 52 and the second binding substance 56, and an anti-mouse IgG antibody (anti-mouse IgG (H+L), rabbit F(ab′)2, product number 566-70621, manufactured by FUJIFILM Wako Pure Chemical Corporation) can be used as the third binding substance 58.

The color development region L3 contains a substance whose color development state changes in response to the first reagent 41. The color development region L3 indicates that the first reagent 41 has been developed to that region by reacting with the first reagent 41 to develop a color or change a color. For example, in a case where a mixed aqueous solution of an iron nitrate aqueous solution and citric acid (manufactured by Fujifilm Wako Pure Chemical Corporation, 038-06925) is used as the first reagent 41, an aspect in which the color development region L3 is constituted of a color reagent immobilization line on which Bromocresol Green (manufactured by FUJIFILM Wako Pure Chemical Corporation) has been immobilized in a line shape is preferable. This aspect is the aspect of the color development region L3 of the present example. As described above, the color development region L3 of the present example is dark green color before reacting with the first reagent 41, and the dark green color is changed to an orange color in a case where the first reagent 41 reaches the color development region L3. The color development region L3 is sometimes referred to as an amplification index region because the timing of supplying the second reagent 46 after the first reagent 41 is developed is indicated by changing the color development state.

The liquid feeding pad 4 is disposed in contact with one end of the carrier 2 and the first reagent 41 is fed to the carrier 2 from the upstream side of the spotting region (constituted of the label holding pad 3). In the liquid feeding pad 4, in a case where the first pressed part 11 is pressed, one end of the liquid feeding pad 4 is immersed in the first reagent holding part 40. The liquid feeding pad 4 is formed of a porous material and absorbs the first reagent 41, and the absorbed first reagent 41 is fed to the carrier 2 by a capillary action.

The absorption pad 6 is disposed in contact with the other end of the carrier 2 and absorbs the sample 50, the first reagent 41, and the second reagent 46, which are developed on the carrier 2. The absorption pad 6 is also formed of a porous material.

In the present embodiment, the first reagent 41 and the second reagent 46 are amplifying liquids that amplify the color development in the assay region L1 and the control region L2 by reacting with both thereof. In a case where a metal-based labeling substance such as a gold colloid is used as the labeling substance 53 as in the present example, for example, silver amplification is used as a method of amplifying the labeling signal of the labeling substance 53. The first reagent 41 and the second reagent 46 are, as an example, amplifying liquids used for silver amplification, and the reaction between the first reagent 41 and the second reagent 46 using the labeling substance 53 as a catalyst is an amplification reaction. By the amplification reaction, silver particles having a particle diameter relatively larger than that of the labeling substance 53 are generated.

More specifically, in the present example, the first reagent 41 is a reducing agent that reduces silver ions, and the second reagent 46 is a silver ion. In a case where the first reagent 41, which is a reducing agent, and the second reagent 46, which is a silver ion, are brought into contact with the labeling substance 53, silver particles 60 (see FIG. 6) are generated, and the generated silver particles 60 deposits on the labeling substance 53 using the labeling substance 53 as a nucleus. By depositing the silver particles 60 on the labeling substance 53, silver particles 60 having a particle diameter larger than that of the labeling substance 53 (see FIG. 6) are generated. Accordingly, the labeling signal issued by the labeling substance 53 is amplified, and as a result, the color development of the labeling substance 53 is amplified in the assay region L1 and the control region L2.

(First Reagent) As the reducing agent as the first reagent 41, any inorganic or organic material or a mixture thereof can be used as long as the silver ion used as the second reagent 46 can be reduced to silver. Preferred examples of the inorganic reducing agent include a reducing metal salt and a reducing metal complex salt, of which the atomic valence is capable of being changed with a metal ion such as Fe²⁺, V²⁺, or Ti³⁺. In a case where an inorganic reducing agent is used, it is necessary to remove or detoxify oxidized ions by complexing or reducing the oxidized ions. For example, in a system in which Fe²⁺ is used as the reducing agent, a complex of Fe³⁺, which is an oxide, is formed using citric acid or ethylenediaminetetraacetic acid (EDTA), which enables the detoxification of the oxidized ions. In the present system, such an inorganic reducing agent is preferably used, and it is more preferable that a metal salt of Fe²⁺ is preferably used.

It is also possible to use a developing agent used in a light-sensitive silver halide photographic material of a wet-type (for example, methyl gallate, hydroquinone, substituted hydroquinone, 3-pyrazolidones, p-aminophenols, p-phenylenediamines, hindered phenols, amidoximes, azines, catechols, pyrogallols, ascorbic acid (or a derivative thereof), and leuco dyes), and other materials obvious to those who are skilled in the related art in the present field, for example, a material described in U.S. Pat. No. 6,020,117A.

As the reducing agent, an ascorbic acid reducing agent is also preferable. The useful ascorbic acid reducing agent includes ascorbic acid, an analogue thereof, an isomer thereof, and a derivative thereof. Preferred examples thereof include D- or L-ascorbic acid and a sugar derivative thereof (for example, γ-lactoascorbic acid, glucoascorbic acid, fucoascorbic acid, glucoheptoascorbic acid, or maltoascorbic acid), a sodium salt of ascorbic acid, a potassium salt of ascorbic acid, isoascorbic acid (or L-erythroascorbic acid), a salt thereof (for example, an alkali metal salt, an ammonium salt, or a salt known in the related technical field), ascorbic acid of the enediol type, ascorbic acid of the enaminol type, and ascorbic acid of the thioenol type. Particularly, D-, L-, or D,L-ascorbic acid (and an alkali metal salt thereof) or isoascorbic acid (or an alkali metal salt thereof) is preferable, and a sodium salt is a preferred salt. A mixture of these reducing agents can be used as necessary.

(Second reagent) The solution containing silver ions, which is used as the second reagent 46, is preferably a solution obtained by dissolving a silver ion-containing compound in a solvent. As the silver ion-containing compound, an organic silver salt, an inorganic silver salt, or a silver complex can be used. An inorganic silver salt or a silver complex is preferable. As the inorganic silver salt, it is possible to use a silver ion-containing compound having a high solubility in solvents such as water, and examples thereof include silver nitrate, silver acetate, silver lactate, silver butyrate, and silver thiosulfate. Silver nitrate is particularly preferable. The silver complex is preferably a silver complex in which silver is coordinated with a ligand having a water-soluble group such as a hydroxyl group or a sulfone group, and examples thereof include silver hydroxythioether.

<Immunochromatographic Method>

An immunochromatographic method will be described with reference to FIG. 6. Here, a case where the sample 50 includes the test substance 51, that is, on the premise that the sample 50 is positive will be described.

First, the sample 50 is spotted on the label holding pad 3 which is the spotting region (Step S1). The test substance 51 in the sample 50, which is spotted on the label holding pad 3, specifically binds to the first binding substance 52 that modifies the labeling substance 53 contained in the label holding pad 3. The sample 50 is developed on the downstream side from the label holding pad 3 in the carrier 2 by the capillary action in the carrier 2. A part of the sample 50 is also developed on the upstream side. The arrow S indicates a state in which the sample 50 is developed.

Next, the first reagent 41 is supplied (Step S2). The first reagent 41 is supplied from the liquid feeding pad 4 side. The first reagent 41 is supplied to the carrier 2 via the liquid feeding pad 4 and is developed on the downstream side.

After that, the process waits until the first reagent 41 is developed on the downstream side (Step S3 and Step S4). “Wait” shown in FIG. 6 means an action of waiting. The first reagent 41 is gradually developed to the downstream side, and the sample 50 to be developed from the label holding pad 3 and the labeling substance 53 modified with the first binding substance 52 are developed to the downstream side to be pushed by the first reagent 41 (Step S3).

The test substance 51 in the sample 50 that has been developed to the downstream side and has reached the assay region L1 is captured by the second binding substance 56 of the assay region L1. That is, the labeling substance 53 is captured in the assay region L1 via the test substance 51 and the first binding substance 52. On the other hand, the labeling substance 53 that is not bound to the test substance 51 passes through the assay region L1 without being captured and is captured by the third binding substance 58 of the control region L2.

In a case where the development of the first reagent 41 proceeds and the first reagent 41 reaches the color development region L3 (Step S4), the color development region L3 reacts with the first reagent 41 to change the color development state. In the present example, the color development region L3 is dark green color before reacting with the first reagent 41, and the dark green color is changed to an orange color by reacting with the first reagent 41.

After the first reagent 41 is sufficiently developed, the second reagent 46 is supplied to the carrier 2 (Step S5). The second reagent 46 is supplied to the carrier 2 from the downstream side of the color development region L3 and is developed on the upstream side. Here, the first reagent 41 is a first amplifying liquid containing a reducing agent that reduces silver ions, and the second reagent 46 is a second amplifying liquid containing silver ions. By reacting the first amplifying liquid with the second amplifying liquid, the silver particles 60 are generated using the gold colloidal particles that are the labeling substance 53 as a catalyst. Accordingly, the labeling signal is amplified (Step S6).

FIG. 7 is a partially broken side view of an assay apparatus 110 in a state where the cartridge 100 is loaded. Hereinafter, a configuration and a function of the assay apparatus 110 will be described with reference to FIG. 7.

In the assay apparatus 110 of the present example, as shown below, the two assay flows of a first assay flow and a second assay flow can be selected. In both of the first assay flow and the second assay flow, it is necessary that the sample 50 is spotted on the carrier 2 of the cartridge 100 before loading. However, in a case where the first assay flow is selected, it is necessary that the supply of the first reagent 41 to the carrier 2 in the cartridge 100 is started by the operation of the user before loading, but in a case where the second assay flow is selected, the supply is started by the internal mechanism of the assay apparatus 110 after the loading.

That is, the first assay flow is a flow in which an assay is performed on the cartridge 100 in a state where the spotting of the sample 50 and the supply of the first reagent 41 are started before loading. In the case of the first assay flow, after the loading, only the supply of the second reagent 46 to the carrier 2, among the first reagent 41 and the second reagent 46, is performed by the assay apparatus 110.

The second assay flow is a flow in which an assay is performed on the cartridge 100 in which only the spotting of the sample 50 is performed before loading. In the case of the second assay flow, after the loading, the supply of both of the first reagent 41 and the second reagent 46 to the carrier 2 is performed by the assay apparatus 110.

Hereinafter, a configuration of the assay apparatus 110 will be described, and then a first assay flow will be described.

(Configuration of Assay Apparatus 110)

As shown in FIG. 7, the assay apparatus 110 includes a first reagent supply mechanism 116 and a second reagent supply mechanism 118 as internal mechanisms. The first reagent supply mechanism 116 is a mechanism for starting the supply of the first reagent 41 from the first reagent holding part 40 to the carrier 2. As the first reagent supply mechanism 116, for example, an actuator such as a solenoid provided with an electromagnet and a plunger movable with respect to the electromagnet is used. For example, as the plunger moves, the plunger abuts on the first pressed part 11 and presses the first pressed part 11. The first reagent supply mechanism 116 is disposed at a position facing the first pressed part 11 of the loaded cartridge 100.

The first reagent supply mechanism 116 is a pressing mechanism that applies a pressing force to the first pressed part 11 from the outside by pressing the first pressed part 11 of the cartridge 100. In a case where a pressing force is applied to the first pressed part 11 by the first reagent supply mechanism 116, the first reagent 41 is supplied from the first reagent holding part 40 to the carrier 2 by the above-described action. In the first assay flow, the first reagent supply mechanism 116 is not used and only in the second assay flow, the first reagent supply mechanism 116 is used.

The second reagent supply mechanism 118 is a mechanism for starting the supply of the second reagent 46 from the second reagent holding part 45 to the carrier 2. Also as the second reagent supply mechanism 118, an actuator such as a solenoid is used similarity to the first reagent supply mechanism 116. The second reagent supply mechanism 118 is disposed at a position facing the second pressed part 12 of the loaded cartridge 100. The second reagent supply mechanism 118 is a pressing mechanism that applies a pressing force to the second pressed part 12 from the outside by pressing the second pressed part 12 of the cartridge 100. In a case where a pressing force is applied to the second pressed part 12 by the second reagent supply mechanism 118, the second reagent 46 is supplied from the second reagent holding part 45 to the carrier 2 by the above-described action. The second reagent supply mechanism 118 is used in both of the first assay flow and the second assay flow. The second reagent supply mechanism 118 can press the second pressed part 12 with a pressing force of 50 N or more. That is, the internal mechanism provided in the assay apparatus 110 can press the second pressed part 12 with a pressing force of 50 N or more.

In addition to the loading part 112, the first reagent supply mechanism 116, and the second reagent supply mechanism 118, the assay apparatus 110 further includes a detection unit 114, a processor 120, and a memory 121 in the case body 111. In FIG. 7, the processor 120 and the memory 121 are illustrated outside the case body 111 of the assay apparatus 110, but this is a schematic diagram and the processor 120 and the memory 121 are actually disposed inside the case body 111.

The detection unit 114 optically detects the color development state of the assay region L1, the control region L2, and the color development region L3, and outputs a detection signal indicating the color development state to the processor 120. The detection unit 114 is image sensor such as a complementary metal oxide semiconductor (CMOS) image sensor and a charge coupled device (CCD) image sensor and images an observation region including an assay region L1, a control region L2, and a color development region L3. Then, the imaged image is output from the detection unit 114 to the processor 120.

In addition, as an example, a light source 115 such as a light emitting diode that illuminates the assay region L1, the control region L2, and the color development region L3 during the imaging is provided on both sides of the detection unit 114.

The processor 120 integrally controls each part of the assay apparatus 110. An example of the processor 120 is a Central Processing Unit (CPU) that performs various types of control by executing a program. The CPU functions as a control unit having a detection unit control unit 122, a color development state discrimination unit 123, a first reagent supply mechanism control unit 124, a second reagent supply mechanism control unit 125, a display control unit 126, and a timer 128 by executing a program. The memory 121 is an example of a memory connected to or built in the CPU as the processor 120. For example, a control program is stored in the memory 121. The processor 120 is realized by the CPU executing a control program.

The detection unit control unit 122 controls the imaging timing by the detection unit 114.

The first reagent supply mechanism control unit 124 operates the first reagent supply mechanism 116 to control the first pressed part 11 to be pressed.

The second reagent supply mechanism control unit 125 operates the second reagent supply mechanism 118 based on the change in the color development state of the color development region to control the second pressed part 12 to be pressed.

The color development state discrimination unit 123 executes the color development region discrimination processing, the control region discrimination processing, and the assay region discrimination processing based on the detection signal output by the detection unit 114. As described above, the detection unit 114 outputs the captured image of the observation region including the assay region L1, the control region L2, and the color development region L3. The color development state discrimination unit 123 executes each of the above-described discrimination processing based on the captured image.

The color development region discrimination processing is a processing of discriminating, based on the image of the imaging region, a change in the color development state of the color development region L3, as an example, whether or not the color has changed from a dark green color, which is the color before the reaction with the first reagent 41, to an orange color. “Presence” of the change in the color development state means that the first reagent 41 is developed to the color development region L3.

The “change in color development state” includes any of an aspect in which a first color different from the color of the carrier changes to another second color (that is, a color change), an aspect in which the color of the carrier changes to another color by developing a color different from that of the carrier (that is, color development), and an aspect in which the density of the color changes (that is, a change in density).

The processor 120 operates the second reagent supply mechanism 118 via the second reagent supply mechanism control unit 125 in a case where the color development state discrimination unit 123 discriminates that the color development state in the color development region L3 has changed.

The control region discrimination processing is a processing of discriminating presence or absence of a change in the color development state of the control region L2 based on the detection signal output by the detection unit 114. In the present example, since a line is expressed in the control region L2 by the labeling substance 53 being captured in the control region, or the silver amplification after capturing the labeling substance 53, presence or absence of the expression of the line in the control region L2 is discriminated. In a case where it is discriminated that the color development state of the control region L2 is changed, that is, the expression in the control region L2 is present, the color development state discrimination unit 123 executes the assay region discrimination processing of the next step.

The assay region discrimination processing is a processing of discriminating presence or absence of a change in the color development state of the assay region L1 based on the detection signal output by the detection unit 114. In the present example, since a line is expressed in the assay region L1 by the labeling substance 53 being captured in the assay region L1, or the silver amplification after capturing the labeling substance 53, presence or absence of the expression of the line in the assay region L1 is determined.

In a case where the color development state discrimination unit 123 discriminates that the change in the color development state in the assay region L1 is present, the processor 120 displays the assay result as “positive” on the monitor 119 via the display control unit 126. In addition, in a case where it is discriminated that the change in the color development state in the assay region L1 is absent, the processor 120 displays the assay result as “negative” on the monitor 119 via the display control unit 126.

In addition to the control program, the memory 121 stores setting information that is preset in order for the processor 120 to perform various types of control. As the setting information, information necessary for the color development state discrimination unit 123 to discriminate a change in the color development state is recorded. Examples of the setting information include a first setting time t1 that is preset, a second setting time t2 that is preset, and a number of times K that is preset, which will be described later. The first setting time t1 is a waiting time until the processor 120 determines the presence or absence of a change in the color development state of the color development region L3 again in a case where the processor 120 has been determined that a change in the color development state of the color development region L3 is absent. The second setting time t2 is a preset time from a preset time point after the cartridge is loaded, and is an allowable time in a case where the presence or absence of the color development state of the color development region L3 is performed repeatedly.

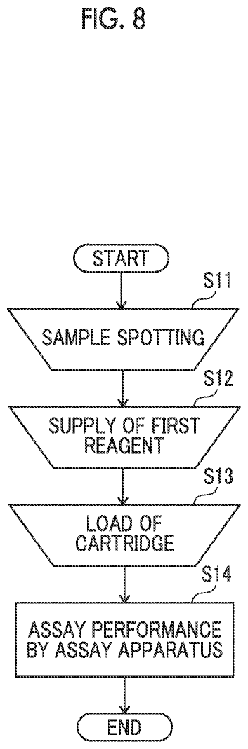

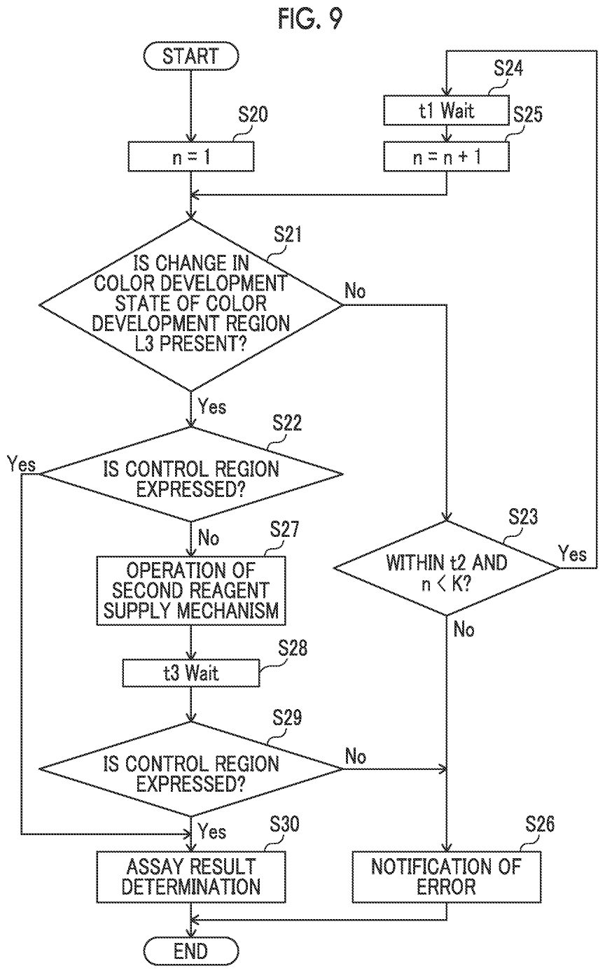

The procedure of the immunochromatographic assay using the assay apparatus 110 according to the present embodiment will be described with reference to FIG. 8 and FIG. 9. Here, a first assay flow that is an aspect in which the supply of the first reagent 41 is performed by the user and the supply of the second reagent 46 is performed by the assay apparatus 110 will be described.

(First Assay Flow)

FIG. 8 is a diagram showing the first assay flow.

First, a user adds dropwise the sample 50 from the dropping port 16 of the cartridge 100 onto the spotting region of the carrier 2 (Step S11).

Next, the user presses the first pressed part 11 of the cartridge 100 to start the supply of the first reagent 41 (Step S12).

After that, the user loads the cartridge 100 into the loading part 112 of the assay apparatus 110 in a state where a power is turned on (Step S13).

An assay of the loaded cartridge 100 is performed in the assay apparatus 110 (Step S14).

The time from the start of the supply of the first reagent 41 until the first reagent 41 is sufficiently developed in the carrier 2 varies depending on each cartridge, but it takes generally about 5 minutes to 10 minutes. The time from the pressing the first pressed part 11 by the user until the cartridge 100 is loaded into the loading part 112 may be set according to the convenience of the user.

FIG. 9 shows a detailed assay flow of an assay performance (Step S14) in the assay apparatus 110 shown in FIG. 8.

By loading the cartridge 100 into the assay apparatus 110, the assay in the assay apparatus 110 (Step S14 in FIG. 8) is started.

As shown in FIG. 9, in the assay apparatus 110, first, n=1 is set in the processor 120 (Step S20). Here, n is a parameter of the number of times of executing the discrimination processing of the color development region L3. The processor 120 discriminates whether or not the color development state of the color development region L3 is changed (specifically, the change from a dark green color to an orange color) (Step S21). Specifically, in a state where the observation region is illuminated by turning on the light source 115, the processor 120 causes the detection unit 114 to perform imaging by operating the detection unit 114. Then, the processor 120 acquires the captured image from the detection unit 114, and discriminates the change in the color development state of the color development region L3 from the acquired captured image. In a case where it is discriminated that a change in the color development state of the color development region L3 is present, that is, in a case where the color of the color development region L3 has changed from a dark green color to an orange color, it means that the first reagent 41 has reached the color development region L3, and the assay region L1 and the control region L2 which are on the upstream side of the color development region L3.

In a case where the color development state of the color development region L3 has changed (Step S21: Yes), the processor 120 discriminates whether or not a line is expressed in the control region L2 (Step S22). In Step S22, the processor 120 discriminates the change in the color development state of the control region L2 from the captured image. The processor 120 discriminates, for example, whether or not the color optical density of the control region L2 reaches a density not less than a preset reference, and in a case where the density is not less than the reference, the processor 120 discriminates that the control region L2 is expressed. The case where it is discriminated that the control region L2 is expressed means that the sample 50 has reached the control region L2 and the assay region L1 on the upstream side thereof, and are subjected to silver amplification, that is, the second reagent 46 has already been supplied.

On the other hand, in a case where the color development state of the color development region L3 has not changed (Step S21: No), the determination of whether or not it is within the second setting time t2 and whether or not the number of times n of discriminating the change in the color development state of the color development region L3 is less than K times (n<K) is performed (Step S23). The preset time point at which the count of the second setting time t2 is started may be the time when the cartridge is loaded, or the time when the preset number of times of the discrimination is ended. In addition, the preset number of times K may be appropriately set to 2 or more.

Here, in a case where the process has exceeded the second setting time t2 or it is not n<K (Step S23: No), the processor 120 notifies the error (Step S26) and ends the assay flow. That is, in the present example, in a case where either of the conditions that the second setting time is within t2 and that n<K is not satisfied, it is regarded as an error. The notification of the error is performed, for example, by displaying an error message on the monitor 119. In addition to displaying the error message on the monitor 119, as a method of notifying the error, the error message may be notified by voice.

On the other hand, in a case where the it is within the second setting time t2 and it is n<K (Step S23: Yes), the process waits until the first setting time t1 elapses (Step S24). In Step S24 of FIG. 9, it is shown as “t1 wait”. The first setting time t1 is, for example, about 30 seconds, and the second setting time t2 is preset to, for example, 20 minutes or the like. After that, n is incremented by 1 (indicated by n=n+1 in FIG. 9) (Step S25), and the process returns to Step S21 of discriminating again whether or not the color development state of the color development region L3 has changed.

In the discrimination of whether or not the control region L2 is expressed (Step S22), in a case where the control region L2 is expressed (Step S22: Yes), since the amplification has already been performed, it is possible to determine the assay result as it is. Therefore, the processor 120 performs the assay result determination in Step S30 without amplification. In the assay result determination in Step S30, the assay result determination is performed by discriminating whether or not the assay region L1 is expressed as it is without amplification (Step S30), and ends the assay flow.

In the assay result determination, for example, the processor 120 discriminates whether the color optical density of the line-shaped assay region L1 reaches a density not less than a preset reference, and in a case where the density is not less than the reference, the processor 120 discriminates that the assay region L1 is expressed. The case where it is discriminated that the assay region L1 is expressed means that the sample 50 is positive, and the case where it is discriminated that the assay region L1 is not expressed means that the sample 50 is negative. In this way, the processor 120 determines the assay result of whether the sample 50 is positive or negative depending on the presence or absence of expression of the assay region L1.

On the other hand, in the discrimination of whether or not the control region L2 is expressed (Step S22), in a case where it is discriminated that the control region L2 is not expressed (Step S22: No), it is necessary to amplify the color development. Since Step S22 is performed in response to the result of the affirmative determination in Step S21, this stage is a state where the first reagent 41 has reached the assay region L1, the control region L2, and the color development region L3.

Therefore, the processor 120 operates the second reagent supply mechanism 118 to start the supply of the second reagent 46 (Step S27). In this way, the processor 120 operates the second reagent supply mechanism 118 only in a case where it is discriminated that the change in the color development state of the color development region L3 is present and the change in the color development state of the control region L2 is absent. In the present embodiment, the processor 120 presses the second pressed part 12 of the cartridge 100 by the second reagent supply mechanism 118. In a case where the second pressed part 12 is pressed, the second pressed part 12 is deformed to sink toward the second reagent holding part 45. Due to this deformation, the sheet member 48 of the second reagent holding part 45 is pressed against the protrusion 34 to break, and the second reagent 46 is supplied onto the carrier 2. After that, until the preset third setting time t3 elapses, the process waits the development of the second reagent 46 (Step S28). In FIG. 9, it is shown as “t3 wait”. The third setting time t3 is set to, for example, about 3 minutes.

After the lapse of the third setting time t3, the processor 120 determines again whether or not the control region L2 is expressed (Step S29).

In the discrimination of whether or not the control region L2 is expressed in Step S29, in a case where the control region L2 is expressed (Step S29: Yes), the processor 120 determines the assay result by discriminating whether or not the assay region L1 is expressed (Step S30), and ends the assay flow.

In a case where it is discriminated that expression in the assay region L1 is present, the processor 120 that has performed the assay result determination displays the assay result as “positive” on the monitor 119. In addition, in a case where it is discriminated that expression in the assay region L1 is absent, the processor 120 displays the assay result as “negative” on the monitor 119.

On the other hand, in the discrimination of whether or not the control region L2 is expressed in Step S29, in a case where the control region L2 is not expressed (Step S29: No), an error is notified (Step S26) and the assay flow ends. In a case where the control region L2 is not expressed after the development of the second reagent 46, there is a possibility that the sample 50 has not been spotted. The assay flow in the assay apparatus 110 is as described above.

As described above, the cartridge 100 according to the present embodiment includes a second reagent holding part 45 that holds the second reagent 46, which is supplied to the carrier 2 after the first reagent 41 is supplied to the carrier 2. The second reagent holding part 45 receives an external force exerted by an internal mechanism provided in the assay apparatus 110 indirectly via the second pressed part 12, to start the supply of the second reagent 46 to the carrier 2. Then, the cartridge 100 includes a suppression structure having a second pressed part 12 that suppresses transmission of an external force exerted by a user to the second reagent holding part 45. Since the cartridge 100 according to the present embodiment includes such a suppression structure, the cartridge 100 can suppress an erroneous operation by the user regarding the supply of the first reagent 41 and the second reagent 46.

The assay apparatus 110 according to the present embodiment includes a loading part 112 into which the cartridge 100 described above is attachably and detachably loaded, and a second reagent supply mechanism 118 as an internal mechanism. According to the assay apparatus 110, the second reagent supply mechanism 118 exerts an external force on the second reagent holding part 45, and thus the supply of the second reagent 46 to the carrier 2 can be started.

In the present embodiment, particularly, the second pressed part 12 transmits the operating force to the second reagent holding part 45 in a case where the pressing force is 50 N or more but does not transmit the operating force in a case where the pressing force is less than 50 N. Therefore, a pressing force for transmitting an operating force that is a force of magnitude necessary for starting the supply of the second reagent 46 to the second reagent holding part 45 is set to 50 N or more, which is assumed as a value that exceeds the upper limit of a pressing force to be exerted by a human finger (that is, a value of a pressing force that is difficult for a human to apply), and thus an erroneous operation can be suppressed. It is more preferable to set the pressing force that can deform the second pressed part 12 to 80 N or more. The upper limit of the setting of the pressing force that can deform the second pressed part 12 is not particularly limited, but it is preferably lower in consideration of the simplicity of selection of the motor and the structural design of the second reagent supply mechanism 118.

The assay apparatus 110 according to the above-described embodiment includes a second reagent supply mechanism 118 which is an internal mechanism, and the second reagent supply mechanism 118 can press the second pressed part 12 of the cartridge 100 with a pressing force of 50 N or more. Therefore, it is possible to start the supply of the second reagent 46 to the carrier 2 with respect to the cartridge 100 in which the supply of the second reagent 46 to the carrier 2 cannot be started depending on the user.

The cartridge 100 according to the present embodiment includes a second pressed part 12 a pressed part that is deformed by receiving a pressing force, and that transmits an operating force for starting the supply of the second reagent 46 to the second reagent holding part 45 by the deformation. However, the pressed part that transmits the operating force that is a force of magnitude necessary for starting the supply of the second reagent 46 to the second reagent holding part 45, may be a pressed part that is displaced by receiving the pressing force, and that transmits the operating force that is a force of magnitude necessary for starting the supply of the second reagent 46 to the second reagent holding part 45 by the displacement.

In the above-described embodiment, the first reagent 41 is the first amplifying liquid and the second reagent 46 is the second amplifying liquid, but the first reagent 41 and the second reagent 46 are not limited to this combination. A combination in which the first reagent 41 is a developing solution and the second reagent 46 is a cleaning liquid, or a combination in which the first reagent 41 is a developing solution or a cleaning liquid and the second reagent 46 is an amplifying liquid may be used.

However, the second reagent 46 is preferably an amplifying liquid that amplifies color development. In a case where the second reagent 46 is an amplifying liquid that amplifies the color development of the assay region L1, the color development of the assay region L1 is amplified, and thus the determination accuracy can be improved.

In addition, as in the present embodiment, the first reagent 41 and the second reagent 46 are preferably the amplifying liquids that amplify the color development of the assay region L1. In a case where the first reagent 41 and the second reagent 46 is an amplifying liquid that amplifies the color development of the assay region L1, the color development of the assay region L1 is amplified, and thus the determination accuracy can be improved.

In the first assay flow described above, since the supply of the first reagent 41 is performed by pressing the first pressed part 11 by the user, the assay apparatus 110 may not include the first reagent supply mechanism 116. It is preferable to provide the first reagent supply mechanism 116 because the second assay flow can be selected. As described above, in the second assay flow, after the user spots the sample 50, the cartridge 100 is loaded into the loading part 112 of the assay apparatus 110 without supplying the first reagent 41. In the assay apparatus 110, in a case where the cartridge 100 is loaded, the processor 120 first operates the first reagent supply mechanism 116 to supply the first reagent 41 to the carrier 2. Subsequent processing is the same as that of the first assay flow descried above.

The cartridge 100 according to the above-described embodiment includes a suppression structure that suppresses the indirect transmission of an external force exerted by the user to the second reagent holding part 45 by structurally devising the second pressed part 12. The form of the suppression structure is not limited to this, and may be a form in which the direct transmission of an external force exerted by the user to the second reagent holding part 45 or the application of an external force by the user to the second reagent holding part 45 is suppressed. The suppression structure in which the external force exerted by the user directly suppresses the second reagent holding part 45 is a shutter or the like, which will be described later, as an example.

In the above-described first assay flow, in a case where the color development state of the color development region L3 has not changed (Step S21: No), the determination of whether or not it is within the second setting time t2 and whether or not the number of times n of discriminating the change in the color development state of the color development region is less than K times (n<K) is performed (Step S23). Then, in a case where the it is within the second setting time t2 and it is n<K, the discrimination of the change in the color development state of the color development region is repeated, and in a case where the process has exceeded the second setting time t2 or n has reached K or more, an error is notified (Step S26). However, in Step S23, only one of the conditions of within the second setting time t2 or less and n<K may be determined. That is, in Step S23, it is determined only whether or not the it is within the second setting time t2, and in a case where it is within the second setting time t2, the discrimination of the presence or absence of the change in the color development state (Step S21) may be repeated, and in a case where it had exceeded the second setting time t2, an error may be notified (step S22). In addition, in Step S23, it is determined only whether or not n<K, and in a case where n<K, the discrimination of the presence or absence of the change in the color development state (Step S21) may be repeated, and in a case where n has reached K times, an error may be notified (Step S26).

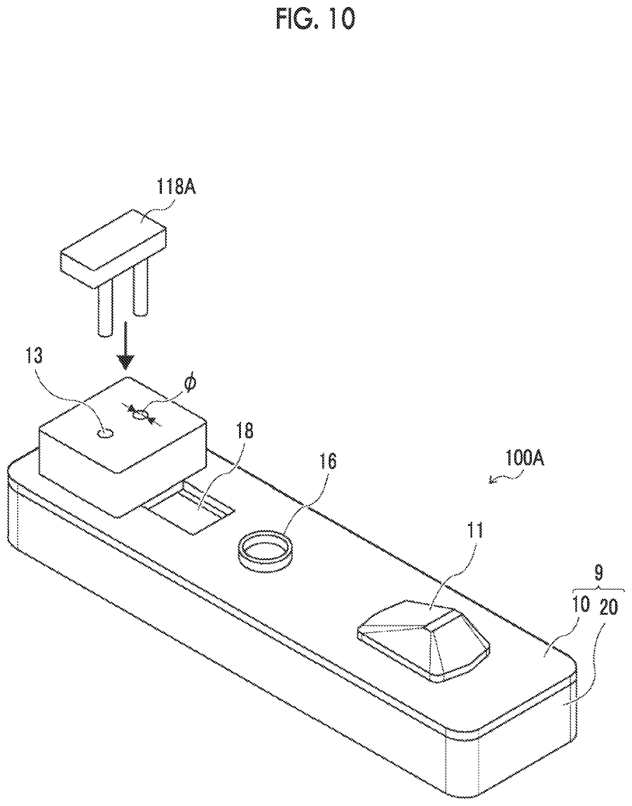

(Cartridge and assay apparatus according to second embodiment) FIG. 10 shows a cartridge 100A of the second embodiment. As will be described later, reference numeral 118A indicates a second reagent supply mechanism that is a part of the internal mechanism of the assay apparatus 110 according to the second embodiment. The same constituent elements as those of the cartridge 100 according to the first embodiment are denoted by the same reference numerals, and detailed description thereof will be omitted. In addition, the assay apparatus 110 according to the second embodiment has substantially the same configuration as the assay apparatus 110 according to the first embodiment, except that a second reagent supply mechanism 118A is changed. Therefore, also in the second embodiment, the assay apparatus 110 will be described by designating the same reference signs as the first embodiment.

The cartridge 100A of the present disclosure is different from the cartridge 100 according to the first embodiment in that the second pressed part 12 is not provided. The cartridge 100A has an opening 13 for exerting an external force on the second reagent holding part 45 in a portion of the cover member 10 that covers the second reagent holding part 45. The assay apparatus 110 includes two rod-like insertion members that can be inserted into the opening 13 of the cover member 10 of the cartridge 100A instead of the second reagent supply mechanism 118 that presses the second pressed part 12 of the cartridge 100.

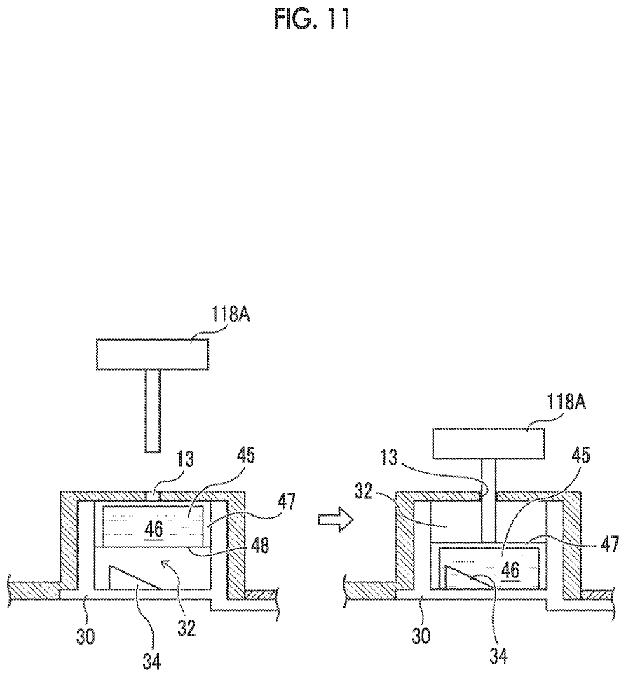

FIG. 11 is a diagram showing a positional relationship between the second reagent supply mechanism 118A and the second reagent holding part 45 in a state where the cartridge 100A is loaded in the loading part 112 of the assay apparatus 110. As shown in the left figure of FIG. 11, the second reagent supply mechanism 118A is provided at a position facing the second reagent holding part 45 of the cartridge 100A loaded in the loading part 112. The two rod-like insertion members of the second reagent supply mechanism 118A are positioned at a position where each can be inserted into the opening 13 of the cover member 10.

In a case of supplying the second reagent 46 to the carrier 2, the second reagent supply mechanism 118A is lowered, and as shown in the right figure of FIG. 11, a rod-like insertion member is inserted into the opening 13. The tip end of the insertion member abuts on the container 47 of the second reagent holding part 45 and presses the container 47, and then the second reagent holding part 45 is pushed downwardly. The second reagent holding part 45 is pushed down, the protrusion 34 penetrates the sheet member 48, and the second reagent 46 flows out from the second reagent holding part 45. Then, the second reagent 46 is supplied to the carrier 2 through an opening (not shown) provided on the bottom surface of the second accommodating part 32 of the multifunctional member 30.

Except for the above-described configuration, the cartridge 100A has the same configuration as the cartridge 100 according to the first embodiment.

The opening 13 has a diameter φ of 5 mm or less, and has a size that a human average-sized finger cannot be inserted. That is, the cover member 10 including the opening 13 has a suppression structure that suppresses the direct and indirect transmission of the external force exerted by the user to the second reagent holding part 45. Since the opening 13 is in a form in which the finger of the user cannot be inserted, it is possible to suppress the user from starting the supply of the second reagent 46, and to suppress an error in the timing of supplying the second reagent.

In addition, the assay apparatus 110 includes a second reagent supply mechanism 118A including an insertion member that can be inserted into the opening 13 of the cartridge 100A as a part of the internal mechanism. Therefore, in the assay apparatus 110, the supply of the second reagent 46 to the carrier 2 can be started by the second reagent holding part 45.

The opening 13 of the cartridge 100A according to the above-described embodiment is not limited to a circular shape as long as the opening 13 is capable of being inserted by the insertion member of the second reagent supply mechanism 118A, which is a part of the internal mechanism of the assay apparatus 110, but of not being inserted by the finger of the user. As the shape of the opening 13, various shapes such as a polygonal shape, a line shape, and a cross shape can be applied. In that case, it is sufficient that the second reagent supply mechanism 118A has the insertion member having a shape corresponding to the shape of the opening 13 in the assay apparatus 110. The opening width of the opening 13 is preferably 5 mm or less. Here, the opening width is, for example, a diameter in a case where the opening 13 is circular, or a length of a short side in a case where the opening 13 is rectangular.

The cartridges 100 and 100A according to each of the above-described embodiments has a configuration in which the second reagent holding part 45 directly or indirectly receives a pressing force as an external force exerted by the second reagent supply mechanism 118 and the second reagent supply mechanism 118A, which are internal mechanisms of the assay apparatus 110 to start the supply of the second reagent 46 to the carrier 2. However, the second reagent holding part 45 is not limited to the present configuration. For example, the second reagent holding part 45 may be configured to include a shutter and to start the supply of the second reagent 46 by opening the shutter. In this case, the second reagent holding part 45 may have a structure that the user cannot open the shutter from the outside of the housing 9. In this case, the mechanism for opening the shutter and the housing constitute a suppression structure that suppresses the direct or indirect transmission of an external force exerted by the user to the second reagent holding part 45. In such a case, the second reagent supply mechanism 118 of the assay apparatus 110 may have a mechanism for opening the shutter.

The cartridges according to the first and second embodiments include suppression structures that suppress the direct or indirect transmission of the external force exerted by the user to the second reagent holding part while allowing the external force exerted by the internal mechanism to be transmitted to the second reagent holding part 45. However, the suppression structure may suppress the application of the external force by the user to the second reagent holding part while allowing the external force exerted by the internal mechanism to be transmitted.

(Cartridge According to Third Embodiment)

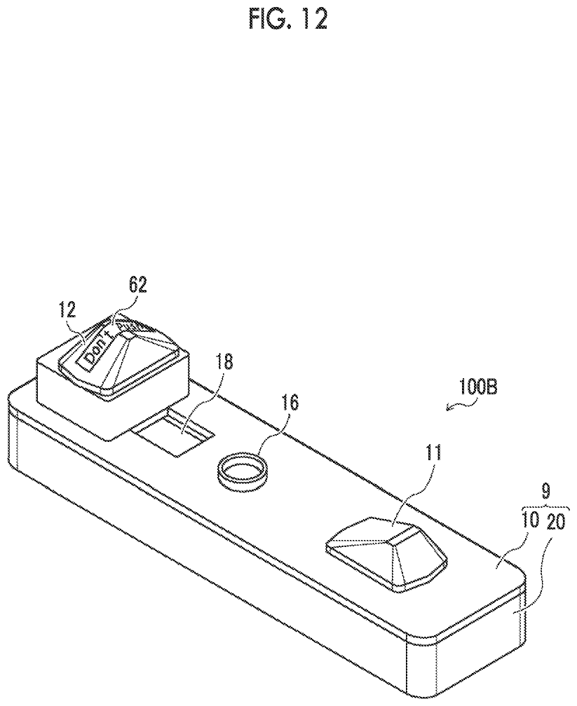

FIG. 12 shows a perspective view of the present cartridge 100B. The same elements as those of the cartridge 100 according to the first embodiment are denoted by the same reference numerals.

The present cartridge 100B includes a label 62 affixed to the second pressed part 12. The label 62 is marked with “Don't Push”. The cartridge 100B according to the present embodiment includes a label 62. Other configurations are the same as the cartridge 100 according to the first embodiment.

In this way, the cartridge 100B according to the present embodiment includes the label 62 that covers at least a part of the second pressed part 12. The label 62 is a form of a coating member that covers the second pressed part 12, and constitutes at least a part of the suppression structure. Since a message indicating prohibition of an operation on the pressed part is displayed on the label 62, it is possible to alert the user and suppress an erroneous operation by the user.

In a case where the cartridge 100B includes the label 62 as a suppression structure, the second pressed part 12 may transmit an external force to the second reagent holding part 45 even in a case of being pressed with a pressing force of 50 N or less, which can be exerted by a human finger. Since the label 62 constitutes a suppression structure and can alert the user, it is possible to suppress an erroneous operation by the user.

In the present example, a coating member that covers only a part of the second pressed part 12 instead of the entire thereof is provided, but a coating member that covers the entire second pressed part 12 may be provided. In a case where the pressed part 12 is hardly visible by the user by covering the second pressed part 12, an erroneous operation by the user can be suppressed. It is preferable that the surface of the second pressed part 12 has a flat surface after being covered with the coating member such that the user does not identify the existence of the second pressed part 12. In the present example, the second pressed part 12 is provided to protrude outward as a part of the cover member 10, for example, it is preferable that the second pressed part 12 is provided at a recessed position (inside the cartridge) from a flat portion on the surface of the cover member 10, and the recessed portion of the cover member 10 is covered with the coating member.

In addition, in a case where the cover member 10 having the opening 13 at a position facing the second reagent holding part 45 is provided instead of the second pressed part 12, as in the cartridge 110A according to the second embodiment, the coating member to cover the opening 13 may be provided.

In the above-described embodiment, as the processor 120 and a hardware structure of a processing unit as internal configurations thereof that executes various types of processing, such as a detection unit control unit 122, a color development state discrimination unit 123, a first reagent supply mechanism control unit 124, and a second reagent supply mechanism control unit 125, various processors shown below can be used. The various processors include, for example, a CPU which is a general-purpose processor executing software to function as various processing units as described above, a programmable logic device (PLD), such as a field programmable gate array (FPGA), which is a processor whose circuit configuration can be changed after manufacture, and a dedicated electric circuit, such as an application specific integrated circuit (ASIC), which is a processor having a dedicated circuit configuration designed to perform a specific process.

One processing unit may be configured by one of these various processors, or may be configured by a combination of two or more processors having the same type or different types (for example, a combination of a plurality of FPGAs and/or a combination of a CPU and an FPGA). In addition, a plurality of processing units may be formed of one processor.

As an example in which a plurality of processing units are configured into a single processor, there is a form in which a single processor is configured by a combination of one or more CPUs and software, and this processor functions as a plurality of processing units. A second example of the configuration is an aspect in which a processor that implements the functions of the entire system including a plurality of processing units using one integrated circuit (IC) chip is used. A representative example of this aspect is a system on chip (SoC). In this way, various processing units are configured by one or more of the above-described various processors as hardware structures.

Furthermore, specifically, an electric circuit (circuitry) obtained by combining circuit elements, such as semiconductor elements, can be used as the hardware structure of the various processors.

The disclosure of Japanese Patent Application No. 2021-050777 filed on Mar. 24, 2021 is incorporated herein by reference in its entirety.

All literatures, patent applications, and technical standards described in the present specification are incorporated in the present specification by reference to the same extent as in a case where the individual literatures, patent applications, and technical standards are specifically and individually stated to be incorporated by reference.

1. A cartridge that is attachably and detachably loaded into an immunochromatographic assay apparatus, the cartridge comprising:
a carrier having a spotting region on which a sample is spotted and an assay region in which a color development state changes depending on whether the sample is positive or negative;
a first reagent holding part that holds a first reagent and that starts a supply of the first reagent to the carrier by directly or indirectly receiving an external force;
a second reagent holding part that holds a second reagent that is supplied to the carrier after the first reagent is supplied to the carrier and that starts a supply of the second reagent to the carrier by directly or indirectly receiving an external force exerted by an internal mechanism provided in the immunochromatographic assay apparatus; and
a suppression structure that suppresses transmission of an external force exerted by a user directly or indirectly to the second reagent holding part or application of an external force by the user to the second reagent holding part, while allowing the external force exerted by the internal mechanism to be transmitted to the second reagent holding part.

2. The cartridge according to claim 1,
wherein the suppression structure has a cover member that covers the second reagent holding part and has an opening for exerting the external force on the second reagent holding part, and
the opening has a form in which a member of the internal mechanism is allowed to be inserted, but a finger of the user is not allowed to be inserted.

3. The cartridge according to claim 2,
wherein an opening width of the opening is 5 mm or less.

4. The cartridge according to claim 1,
wherein the suppression structure has a pressed part that is deformed or displaced by receiving a pressing force as the external force and that transmits an operating force that is a force of magnitude necessary for starting the supply of the second reagent to the second reagent holding part by the deformation or the displacement.

5. The cartridge according to claim 4,
wherein the pressed part transmits the operating force to the second reagent holding part in a case where the pressing force is 50 N or more but does not transmit the operating force in a case where the pressing force is less than 50 N.

6. The cartridge according to claim 1, further comprising:
a cover member having a pressed part that is deformed or displaced by receiving a pressing force as the external force and that transmits an operating force that is a force of magnitude necessary for starting the supply of the second reagent to the second reagent holding part by the deformation or the displacement, or an opening for exerting the external force on the second reagent holding part,
wherein the suppression structure has the pressed part or a coating member that covers the opening.

7. The cartridge according to claim 1,
wherein at least the second reagent among the first reagent and the second reagent is an amplifying liquid that amplifies color development in the assay region.

8. The cartridge according to claim 1,
wherein the first reagent and the second reagent are amplifying liquids that amplify color development in the assay region by reacting with both of the first reagent and the second reagent.

9. The cartridge according to claim 1,
wherein the carrier further includes a color development region in which a color development state changes by a reaction with the first reagent, and
in a case where a direction toward the assay region with respect to the spotting region is defined as a downstream side of the carrier, the color development region is disposed on a downstream side of the assay region and the first reagent holding part is provided on an upstream side of the spotting region.

10. The cartridge according to claim 1,
wherein in a case where a direction toward the assay region with respect to the spotting region is defined as a downstream side of the carrier, the carrier has a control region that is provided on a downstream side of the assay region and that shows a development of the sample supplied from the spotting region to the carrier in the assay region by a change in color development state.

11. An immunochromatographic assay apparatus comprising:
a loading part in which the cartridge according to claim 1 is attachably and detachably loaded; and
the internal mechanism.

12. The immunochromatographic assay apparatus according to claim 11,
wherein the suppression structure has a cover member that covers the second reagent holding part and has an opening for exerting the external force on the second reagent holding part, and
the opening has a form in which a member of the internal mechanism is allowed to be inserted, but a finger of the user is not allowed to be inserted, and
wherein the internal mechanism includes an insertion member capable of being inserted into the opening.

13. The immunochromatographic assay apparatus according to claim 11,
wherein the suppression structure has a pressed part that is deformed or displaced by receiving a pressing force as the external force and that transmits an operating force that is a force of magnitude necessary for starting the supply of the second reagent to the second reagent holding part by the deformation or the displacement, and
wherein the internal mechanism is capable of pressing the pressed part with a pressing force of 50 N or more.
